(19) United States
(12) Patent Application Publication
(10) Pub. No.: US 2008/0303604 A1
(43) Pub. Date: Dec. 11, 2008

(54) TRANSMISSION CABLE CAPABLE OF CONTROLLING AND REGULATING ITS CHARACTERISTIC IMPEDANCE AND ELECTROMAGNETIC INTERFERENCE SIMULTANEOUSLY

(76) Inventor: Vincent Ao, Taipei (TW)

Correspondence Address: BIRCH STEWART KOLASCH & BIRCH, PO BOX 747, FALLS CHURCH, VA, 22040-0747, US

(21) Appl. No.: 11/759,754

(22) Filed: Jun. 7, 2007

(51) Int. Cl. H04B 3/28

(52) U.S. Cl. 333/12

(57) ABSTRACT

Disclosed is a transmission cable capable of controlling and regulating its characteristic impedance and electromagnetic interference simultaneously. The transmission cable comprises at least two conduction wires, which are twisted with each other along a longitudinal direction of the transmission cable. In the design of the transmission cable, the electromagnetic interference is controlled through the twisting of the conduction wires (for example, twisted pair cable). In addition, the two conduction wires tightly contact each other without any gap therebetween, thus achieving the control of its characteristic impedance.

### BACKGROUND OF THE INVENTION

1. Field of the Invention

The present invention relates to a transmission cable, and in particular to a transmission cable, of which the characteristic impedance and electromagnetic interference (EMI) can be controlled and regulated simultaneously.

2. The Prior Arts

In order to fulfill the requirement in transmitting low-voltage differential signals (LVDS), the conduction wire utilized in transmitting LVDS must have 100Ω characteristic impedance and controlled EMI, thus being able to transmit signals and commands correctly, otherwise, signal reflection and noise interference incurred will lead to signal loss, deformation, and distortion. In general, the cable used in transmitting LVDS can be the conventional straight cable, flexible printed-circuit-board (PCB), and coaxial cable, etc. However, the flexible PCB and the coaxial cable have the disadvantages of high cost, and though the cost of straight cable is lower, yet it is liable to have the problem of electromagnetic interference (EMI).

In order to solve the problem of EMI for the straight cable, several anti-EMI Shield Sheaths have been proposed by various manufacturers. For example, U.S. Pat. Nos. 6,162,086 and 6,179,662 are both related to this kind of technology. However, the utilization of this shield sheath will cause the enlargement of the space occupied by the transmission cable. In certain application, the volume occupied by transmission cable is not allowed to get too large. Thus, this kind of shield sheath is not suitable to use in this condition.

Though in EMI control, the Twisted Pair Cable has rather superior performance and effectiveness; meanwhile, its cost is low, yet there exist gaps or spacings between two interwinding conduction wires in a twisted pair cable, so that the control of characteristic impedance for the twisted pair cable is not very satisfactory.

In general, the twisted pair cable is an ordinary cable of two mutually insulating conduction wires interwinding according to a specific specification (usually interwinding in a clockwise direction). In the past, the twisted pair cable is mainly used to transmit analog signal, however, recently, it is likewise suitable for use in transmitting digital signals. In twisting two insulated copper conduction wires according to a specific specification, the interference to the signals transmitted therein can be significantly reduced. As such, the electromagnetic radiations generated by the signals transmitted in a conduction wire is effectively offset and cancelled by electromagnetic radiations generated by the signals transmitted in the other conduction wire. For detailed information concerning the technical characteristics of the twisted pair cable, please refer to U.S. Pat. No. 4,486,619.

With a view to achieve the objective of adjusting and controlling the characteristic impedance and electromagnetic interference simultaneously while reducing its cost the inventor of the present case proposes a transmission cable incorporating the characteristic structures of twisted cable and straight cable.

### SUMMARY OF THE INVENTION

A primary objective of the present invention is to provide a transmission cable, that is capable of adjusting and controlling its characteristic impedance and electromagnetic interference simultaneously, while having the characteristic structures of twisted cable and straight cable, thereby achieving the purpose of adjusting and controlling its characteristic impedance and electromagnetic interference simultaneously.

To achieve the above-mentioned objective, the transmission cable capable of controlling and adjusting its characteristic impedance and electromagnetic interference simultaneously comprises at least two conduction wires, which are twisted and inter-wound with each other along a longitudinal direction of the transmission cable. As such, in the transmission cable of the present invention, in addition to controlling its electromagnetic interference through twisting the two conduction wires (for example, the twisted pair cable) of the transmission cable, moreover, the two conduction wires are made to tightly contact each other without any gap or spacing therebetween, thereby further controlling its characteristic impedance.

Further applicable scopes of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIGS. 1A and 1B are respectively schematic diagrams of a manufacturing method of a transmission cable capable of controlling and regulating its characteristic impedance and electromagnetic interference simultaneously.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

In the following illustration, the transmission cable capable of controlling and regulating its characteristic impedance and electromagnetic interference simultaneously of the present invention will be described in detail with reference to the attached drawings.

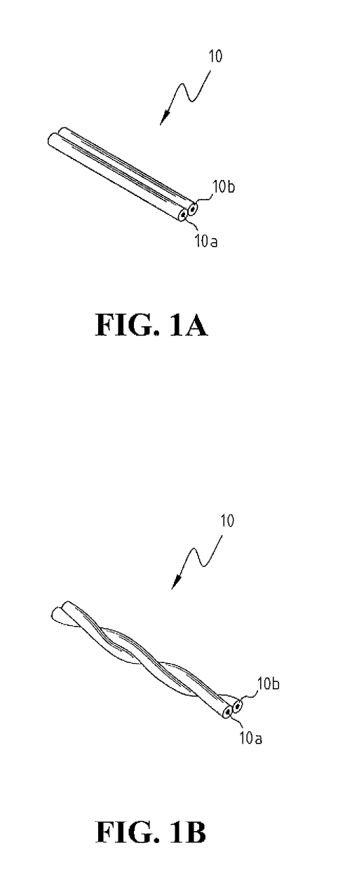

First, referring to FIGS. 1A and 1B. FIGS. 1A and 1B are the schematic diagrams respectively of a manufacturing method of a transmission cable capable of controlling and regulating its characteristic impedance and electromagnetic interference simultaneously. As shown in FIG. 1A, a transmission cable 10 of straight cable type is provided. The transmission cable 10 comprises at least two conduction wires, and each of the conduction wires includes at least a metal wire 10a and an insulation sheath 10b wrapping around the metal wire 10a. It has to be especially noted that, the transmission cable 10 of the above-mentioned straight cable type refers to two conduction wires tightly contact and bind each other without any gap or spacing therebetween. As such, due to the fact that there does not exist any gap between the two wires in a transmission cable 10, thus the characteristic impedance of the transmission cable can be controlled and regulated effectively. Subsequently, the two conduction wires in a transmission cable 10 shown in FIG. 1A are twisted relative to each other along a longitudinal direction of the transmission cable 10, as shown in FIG. 1B. As such, the transmission cable 10 is capable of controlling its electromagnetic interference effectively by means of its twisted cable structure.

Compared with the conventional straight pair cable, the transmission cable 10 of the present invention as shown in FIG. 1B is additionally provided with a twisted cable structure, thus being able to control its electromagnetic interference effectively. The effectiveness in controlling the electromagnetic interference is affected by a twist deviation of the two conduction wires relative to the longitudinal direction of the transmission cable 10.

Moreover, compared with conventional twisted pair cable, the transmission cable 10 of the present invention as shown in FIG. 1B is additionally provided with a straight cable structure, thus being able to control its characteristic impedance effectively. In this structure, the effectiveness in controlling the characteristic impedance is affected by the distance between the two metal wires 10a of the two conduction wires in transmission cable 10, and the constant of characteristic impedance of the insulation sheath 10b.

As such, the transmission cable 10 of the present invention as shown in FIG. 1B is provided with the characteristic structures of both twisted cable and straight cable concurrently, thereby realizing the objective of controlling and regulating the characteristic impedance and electromagnetic interference at the same time.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements that are within the scope of the appended claims.

What is claimed is:

1. A transmission cable capable of controlling and regulating its characteristic impedance and electromagnetic interference simultaneously, said transmission cable comprising at least two conduction wires, and said two conduction wires twisted with each other along a longitudinal direction of said transmission cable, and the improvements comprising:
said two conduction wires tightly contact and bind together without any gap therebetween.

2. The transmission cable as claimed in claim 1, wherein each of said conduction wires comprises at least a metal wire and an insulation sheath wrapped around said metal wire.

3. The transmission cable as claimed in claim 2, wherein the effectiveness in controlling its characteristic impedance is affected by a distance between the two metal wires of said two conduction wires in said transmission cable, and the constant of characteristic impedance of said insulation sheath.

4. The transmission cable as claimed in claim 1, wherein the effectiveness in controlling the electromagnetic interference is affected by a twist deviation of said two conduction wires relative to the longitudinal direction of said transmission cable.
